(19) United States
(12) Patent Application Publication
(10) Pub. No.: US 2013/0316587 A1
(43) Pub. Date: Nov. 28, 2013

(54) CONNECTOR

(71) Applicant: KYOCERA CONNECTOR PRODUCTS CORPORATION, KANAGAWA (JP)

(72) Inventors: NAOKI TAKAHASHI, KANAGAWA (JP); NORIYUKI AKAI, KANAGAWA (JP); HIDEHARU TAMAI, KANAGAWA (JP)

(73) Assignee: KYOCERA CONNECTOR PRODUCTS CORPORATION, KANAGAWA (JP)

(21) Appl. No.: 13/900,623

(22) Filed: May 23, 2013

(30) Foreign Application Priority Data
May 28, 2012 (JP) 2012120754

(51) Int. Cl. H01R 12/72

(52) U.S. Cl. CPC H01R 12/722
USPC 439/630

(57) ABSTRACT

A connector includes an insulator including a connecting-object insertion/removal groove, contact insertion grooves arranged in one direction, and partition walls which partition mutually adjacent the contact insertion grooves; and contacts, each of which including a base portion, fixed to the insulator, an elastically-deformable portion, and a contact portion which comes in contact with a corresponding terminal of the connecting object that is inserted into the connecting-object insertion/removal groove, wherein the contacts are inserted into the contact insertion grooves. A first recess is formed at a side of the elastically-deformable portion of at least one contact, the first recess facing an adjacent the partition wall in the one direction and forming a space in the one direction between the first recess and the adjacent partition wall.

### CROSS REFERENCE TO RELATED APPLICATION

The present invention is related to and claims priority of the following co-pending application, namely, Japanese Patent Application No. 2012-120754 filed on May 28, 2012.

### FIELD OF THE INVENTION

The present invention relates to a connector to which a thin plate-like connecting object, such as card board or an FPC (Flexible Printed Circuit), etc., is removably inserted.

### BACKGROUND OF THE INVENTION

A connector via which a circuit board (rigid board) and a thin plate-like (thin sheet or thin plate) connecting object (such as an expansion card, a PCI card or an FPC, etc.) are electrically connected is usually provided with an insulator and a plurality of contacts. The insulator is provided with a groove into which the connecting object is insertable, and from which the connecting object is removable, and a plurality of contact insertion grooves which are elongated in the connecting object insertion/removal direction and arranged in a direction orthogonal to the connecting object insertion/removal direction, and the plurality of contacts are inserted into the plurality of contact insertion grooves of the insulator, respectively. Furthermore, the insulator is provided with a plurality of partition walls so that each partition wall separates adjacent contact insertion grooves from each other. On the other hand, the plurality of contacts are each provided with a base portion that is fixed to the inner side of each contact insertion groove, an elastically deformable portion which extends from the base portion in the insertion/removal direction of the connecting object and is elastically deformable in the thickness direction of the connecting object, and a contact portion formed on the elastically deformable portion.

The connector is installed onto a circuit board with the contacts connected to a circuit pattern formed on a surface of the circuit board.

Upon the connecting object being inserted into the connecting-object insertion/removal groove of the insulator, terminals provided on the connecting object come into contact with each contact portion of the plurality of contacts while elastically deforming the corresponding elastic deformable portion of each contact, so that the circuit board and the connecting object are electrically connected to each other via the plurality of contacts.

Examples of a connector of the related art are disclosed in Japanese Patent Nos. 4,825,046 and 4,353,436.

Recently, in notebook computers and tablet computers, due to improvements in data transmission speeds and increasing amounts of motion-picture/still-picture information, there is a need to improve the transmission speed within the device. Furthermore, it is similarly also necessary to increase the transmission speed between the module boards (each of which a memory and a module are mounted) that are connected to a connector, which is installed on a main board, and the main board. To improve the high frequency property of an electrical signal fed to this type of connector (the contacts thereof), it is required to make the impedance (value) of the connector as close as possible to the impedance (value) of the circuit board and the connecting object.

However, the insulator is provided with partition walls which are formed between the plurality of contact insertion grooves so that each partition wall separates adjacent contact insertion grooves from each other, and the relative permittivity of the synthetic resin which forms the insulator is usually high (e.g., approximately three to four). Moreover, since the elastically deformable portion of each contact approaches (the side surface of) the partition wall, to which the entire side surface of the elastically deformable portion faces, extremely closely, there is hardly any gap (air layer) formed between the elastically deformable portion and the partition wall.

Accordingly, such a type of connector of the related art has a structure in which the coupling capacitance between adjacent contacts easily increases, and the impedance (value) of the connector tends to decrease largely compared to the impedance (value) of the circuit board and the connecting object.

### SUMMARY OF THE INVENTION

The present invention provides a connector in which a plurality of contacts are arranged in an insulator and supported thereby, and which is configured to be capable of improving the high frequency property of the connector.

According to an aspect of the present invention, a connector is provided, including an insulator including a connecting-object insertion/removal groove, into which a thin plate-like connecting object having terminals on one side thereof is removably insertable, a plurality of contact insertion grooves arranged in one direction, and partition walls which partition mutually adjacent the contact insertion grooves; and a plurality of contacts, each of the contacts including a base portion, which is fixed to the insulator, an elastically-deformable portion which is elastically deformable and extends from the base portion in an insertion/removal direction, and a contact portion which is formed on the elastically-deformable portion and comes in contact with a corresponding terminal of the terminals of the connecting object that is inserted into the connecting-object insertion/removal groove, wherein the contacts are inserted into the contact insertion grooves, respectively. A first recess is formed at a side of the elastically-deformable portion of at least one of the contacts, the first recess facing an adjacent the partition wall in the one direction and forming a space in the one direction between the first recess and the adjacent partition wall.

It is desirable for the first recess to be formed on the elastically-deformable portion over the entirety thereof, in the plate-thickness direction of the connecting object.

It is desirable for the first recess to be formed on the elastically-deformable portion at a location different to that of the front end of the elastically-deformable portion, and for the contact portion to be formed on the front end of the elastically-deformable portion.

It is desirable for the first recess to be formed on the elastically-deformable portion at a portion excluding a base-end portion that is communicably connected with the base portion and the front end portion.

It is desirable for a second recess to be formed on a side of the base portion of each of the contacts to which the first recess is formed, the second recess facing an adjacent the partition wall in the one direction, and for the second recess to define a gap between the second recess and the adjacent partition wall in the one direction.

It is desirable for a gap between a connecting-object supporting portion that supports the other side of the connecting object, when the connecting object is inserted into the connecting-object insertion/removal groove, and the contact portion of the elastically-deformable portion, in a free state, to be smaller than a plate thickness of the connecting object.

According to the connector of the present invention, at least one of the contacts, arranged in one direction, is provided with a first recess on the side surface of the elastically deformable portion thereof. The first recess faces the adjacent partition wall in this one direction, and a gap (air space) is formed between the first recess and the adjacent partition wall. The relative permittivity of this gap (air space) is 1, thus being lower than the relative permittivity of a typical insulator (partition wall).

Accordingly, in the connector according to the present invention, the coupling capacitance between adjacent contacts does not easily increase, so that the impedance (value) of the connector can be brought closer to the impedance (value) of the circuit board and the connecting object compared to a connector of the related art having no recess (that corresponds to the first recess provided in the present invention) and in which the entire side surface of the elastically deformable portion closely approaches the partition wall. Therefore, the high frequency property of an electrical signal fed to the connector (the contacts thereof) can be improved.

### BRIEF DESCRIPTION OF THE DRAWINGS

FIG. 1 is a rear perspective view of an embodiment of a connector, according to the present invention, installed onto a circuit board, and a card board in a separated state, as viewed from above;

FIG. 2 is a front perspective view of the connector installed onto the circuit board, and the card board in a separated state, as viewed from below;

FIG. 3 is an exploded perspective view of the connector, as viewed from above;

FIG. 4 is an exploded perspective view of the connector, as viewed from below;

FIG. 5 is a perspective view of an upper contact;

FIG. 6 is a plan view of an upper contact;

FIG. 7 is a perspective view of a lower contact;

FIG. 8 is a front elevational view of the connector;

FIG. 9 is a cross sectional view taken along the line IX-IX shown in FIG. 8;

FIG. 10 is a cross sectional view taken along the line X-X shown in FIG. 8;

FIG. 11 is a cross sectional view taken along the line XI-XI shown in FIG. 8;

FIG. 12 is a cross sectional view taken along the line XII-XII shown in FIG. 8;

FIG. 13 is an enlarged view of section XIII shown in FIG. 12;

FIG. 14 is a cross sectional view taken along the line XIV-XIV shown in FIG. 11;

FIG. 15 is a plan view of the connector and the card board which is inserted into the connector;

FIG. 16 is a plan view showing the connector and the card board, inserted into the connector, shown in cross section;

FIG. 17 is a cross sectional view taken along the line XVII-XVII shown in FIG. 15;

FIG. 18 is a cross sectional view taken along the line XVIII-XVIII shown in FIG. 15;

FIG. 19A is a plan view showing the positional relationship between the terminals of the card board and the contact portions, when the card board is inserted into the connector of the present invention at a correct position;

FIG. 19B is a plan view showing the positional relationship between the terminals of the card board and the contact portions, when the card board is inserted into the connector of the present invention at a position which is slightly displaced to one side from the correct position of the card board;

FIG. 19C is a plan view showing the positional relationship between the terminals of the card board and the contact portions, when the card board is inserted into the connector of a comparative embodiment at a position which is slightly displaced to one side from the correct position of the card board;

FIG. 20 is a plan view of an elastically deformable portion of an upper contact of a comparative embodiment (modified embodiment);

FIG. 21 is a graph showing the impedance when an electrical signal is supplied from the circuit board to the circuit board, the connector, and the card board; and

FIG. 22 is a plan view of an elastically deformable portion of an upper contact of a modified embodiment with the front end thereof omitted.

### BRIEF DESCRIPTION OF THE PREFERRED EMBODIMENT

An embodiment of a connector according to the present invention will be hereinafter discussed with reference to the drawings. In the following descriptions, forward and rearward directions, leftward and rightward directions, and upward and downward directions of the connector 10 are determined with reference to the directions of the double-headed arrows shown in the drawings.

A connector 10 is a connector to which a module card board 55 (e.g., a memory-expansion card, a PCI card, or a wireless LAN card, etc.)(hereinafter referred as a “card board”), provided inside a PC (personal computer) is removably insertable. The connector 10 is provided with an insulator 15, upper contacts 30, lower contacts 42, and two mounting clips 51 which constitute major components of the connector 10.

The insulator 15 is formed from electrically-insulative and heat-resistant synthetic resin by injection molding. The insulator 15 is provided, on the front thereof except the left and right ends, with a card insertion groove (connecting-object insertion/removal groove) 16 which is recessed rearward to a middle part of the insulator 15. The insulator 15 is provided, on the rear side thereof except the left and right ends, with a contact receiving recess 17. The contact receiving recess 17 is provided, positioned to the left of a central portion of the contact receiving recess 17 in the left/right direction, with a partition projection 18 which partitions the contact receiving recess 17 into left and right contact receiving recesses. The insulator 15 is provided, at the front thereof at the left and right ends of the insulator 15, with a left and right pair of mounting-clip relief recesses 19, respectively. In addition, the insulator 15 is provided, at the left and right rear side portions thereof, with a pair of left and right mounting-clip installation grooves 20 which linearly extend in the rearward direction, respectively. Furthermore, the insulator 15 is provided, in the rear surface thereof (in the front surface of the contact receiving recess 17), with a plurality of upper-contact insertion grooves (contact insertion grooves) 22 which linearly extend in a forward direction and are arranged in the leftward/rightward direction (in one direction) at predetermined intervals. More specifically, a total of twelve (12) upper-contact insertion grooves 22 are formed at a portion on the left side of the partition projection 18, and a total of twenty two (22) upper-contact insertion grooves 22 are formed at a portion on the right side of the partition projection 18. The front end portion of each upper-contact insertion groove 22 is open and is communicably connected with the card insertion groove 16. The insulator 15 is provided with a total of thirty two (32) partition walls 23 which partition mutually adjacent (neighboring) upper-contact insertion grooves 22. Furthermore, a plurality of lower-contact insertion grooves 24, which are formed on the rear surface of the insulator 15 (the front surface of the contact receiving recess 17), are arranged in the leftward/rightward direction at predetermined intervals and are positioned lower than the upper-contact insertion grooves 22, and are displaced in the leftward/rightward direction from the upper-contact insertion grooves 22. The insulator 15 is provided with a total of thirty two (32) partition walls 28 which partition mutually adjacent (neighboring) lower-contact insertion grooves 24. The lower-contact insertion grooves 24 linearly extend forwardly from the rear surface of the insulator 15. Twelve (12) lower-contact insertion grooves 24 are formed at the portion at the left side of the partition projection 18, and twenty two (22) lower-contact insertion grooves 24 are formed at the portion at the right side of the partition projection 18. The front end of each lower-contact insertion grooves 24 is open and is communicably connected with the card insertion groove 16. An erroneous-insertion prevention wall 25, which is positioned inside the card insertion groove 16 along a common extension line with that of the partition projection 18, extends linearly in the forward/rearward direction. The card insertion groove 16 is partitioned into a left space and a right space by the erroneous-insertion prevention wall 25. Furthermore, the insulator 15 is provided with an underside recess 26, having a U-shape in an underside plan view. The part of the underside of the insulator 15 in which the underside recess 26 is not formed (i.e., the front half portion of the underside of the insulator 15 except the left and right side portions) defines an underside projection 15a which projects downwardly by one step with respect to the undersurface of the underside recess 26. Furthermore, a substantially cylindrical shaped mounting projection 27 is provided on the undersurface of a rear end portion of each left and right side of the insulator 15 and projects downward therefrom. The thickness of the insulator 15 (vertical (upward/downward) dimensions including the mounting projections 27) is approximately 3.0 mm.

A total of thirty four (34) upper contacts 30 are each formed from a thin plate made of a spring resilient copper alloy (e.g., phosphor bronze, beryllium copper or titanium copper) or a spring resilient Corson-copper alloy and formed into the shape shown in the drawings using a progressive die (by stamping), and is firstly coated with nickel (Ni) plating as base plating and subsequently with gold (Au) plating.

The upper contacts 30 are each provided with a base portion 31, defining a central portion, an elastically-deformable portion 32 which extends forwards (insertion/removal direction of the card board 55 with respect to the insulator 15) from the base portion 31 and elastically deforms in a (vertical(upward/downward)) direction that is orthogonal to the plate-thickness direction (leftward/rightward direction) thereof, a rearward-extending portion 35 which extends rearwardly from the base portion 31, and a tail piece 36 extending rearwardly from a lower rear-end of the rearward-extending portion 35. The front end of the elastically-deformable portion 32 is provided with a contact portion 33, which is V-shaped in a side elevation view (i.e., the contact portion 33 bends obliquely downward and at a midpoint of the contact portion 33 bends obliquely upward in the forward direction). A notch 34 is formed on the top surface of the upper contacts 30 between the base portion 31 and a base end portion 32a (a curved part communicably connected with the base portion 31) of the elastically-deformable portion 32. Due to the formation of the notch 34, the spring-length (dimensions in the forward/rearward direction) of the elastically-deformable portion 32 increases, and hence, the elastically-deformable portion 32 can exhibit a favorable spring property.

A recessed portion (first recess) 37 is formed on the left side surface of the elastically-deformable portion 32, at portion excluding the base end portion 32a and the contact portion 33 (a portion positioned between the base end portion 32a and the contact portion 33). As shown in the drawings, the recessed portion 37 is formed on the left side surface of the elastically-deformable portion 32 across the entire height from the upper end to the lower end of the elastically-deformable portion 32. The front and rear ends of the recessed portion 37 are communicably connected with the contact portion 33 and the base end portion 32a, respectively, and respectively form inclination surfaces 32b and 32c which are inclined with respect to a plane that is orthogonal to the forward/rearward direction. Due to the gradually-changing shape of the inclination surfaces 32b and 32c, the stress occurring at the stepped portions (ridges) of the recessed portion 37 when the elastically-deformable portion 32 elastically deforms can be effectively dispersed (concentration of stress at the stepped portions can be prevented), and hence, plastic deformation of the elastically-deformable portion 32 can be prevented.

A round recess (second recess) 38 is formed in approximately the central portion of the left side surface of the base portion 31. Furthermore, an abutment projection 39 is provided on the rear side of the upper surface of the base portion 31 and projects upwardly. A lock-engagement projection 40 is provided on the underside of the base portion 31 and projects downwardly therefrom.

The plate thickness (leftward/rightward dimensions) of each upper contact 30 is approximately 0.2 mm, except the portions at which the recessed portion 37 and the round recess 38 are formed. Since the depth (dimensions in the leftward/rightward direction) of the recessed portion 37 (excluding the inclination surfaces 32b and 32c) is 0.05 mm, the part at which the recessed portion 37 (excluding the inclination surfaces 32b and 32c) is formed has a plate thickness of 0.15 mm.

A total of thirty four (34) lower contacts 42, formed from the same material as that of the upper contacts 30, are produced according to the same manufacturing procedure as that for the upper contacts 30. Each lower contact 42 is provided with a base portion 43, including lock-engagement projections 44 on the left and right sides thereof, an elastically-deformable portion 45 extending in an upwardly inclined forward direction from the base portion 43 and elastically deformable in the thickness direction (upward/downward direction) thereof, an L-shaped rearwardly-extending portion 46 extending upward from the base portion 43 and thereafter extending in the rearward direction, and a tail piece 47 which extends rearwardly from the rear lower end of the rearwardly-extending portion 46. The front end of the elastically-deformable portion 45 is provided with a contact portion 48, which is V-shaped in a side elevation view (i.e., the contact portion 48 bends obliquely upward and at a midpoint of the contact portion 48 bends obliquely downward in the forward direction). A linear contact protrusion 49, which extends in the forward/rearward direction, is integrally formed on an apex of the contact portion 48 and protrudes upward therefrom.

The upper contacts 30 and the lower contacts 42 are respectively inserted into the upper-contact insertion grooves 22 and the lower-contact insertion grooves 24 from the rear side of the insulator 15.

When the upper contacts 30 and the lower contacts 42 are being assembled into the insulator 15, first the lower contacts 42 are inserted into the lower-contact insertion grooves 24, respectively, from the rear side of the insulator 15, the underside of each base portion 43 contacts the base surface of the lower-contact insertion grooves 24, and each rearwardly-extending portion 46 and each tail piece 47 are positioned above the underside recess 26. Thereupon, since the lock-engagement projections 44 projecting from the left and right sides of each base portion 43 respectively dig into (bite) the left and right side surfaces (the side surfaces of the partition walls 28) of the corresponding lower-contact insertion grooves 24, each base portion 43 is fixed to each corresponding lower-contact insertion grooves 24 (the partition walls 28). On the other hand, since minute (slight) gaps (spaces) are formed between the left and right side surfaces of the elastically-deformable portion 45 of each lower contact 42 and the left and right side surfaces (side surfaces of the partition walls 28) of the corresponding lower-contact insertion groove 24, each elastically-deformable portion 45 is elastically deformable in the upward and downward directions within the corresponding lower-contact insertion groove 24.

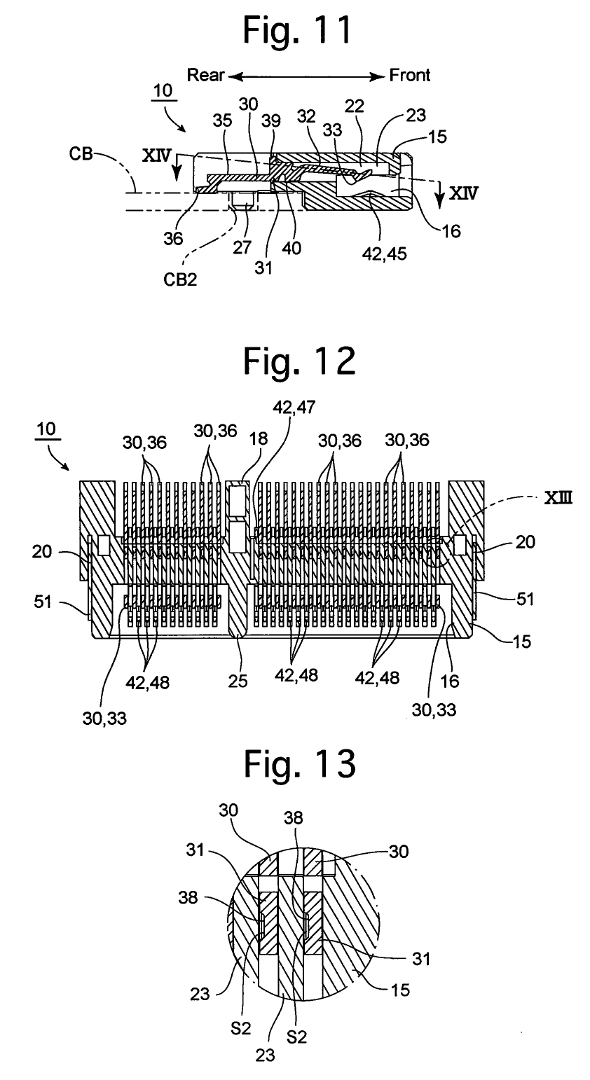

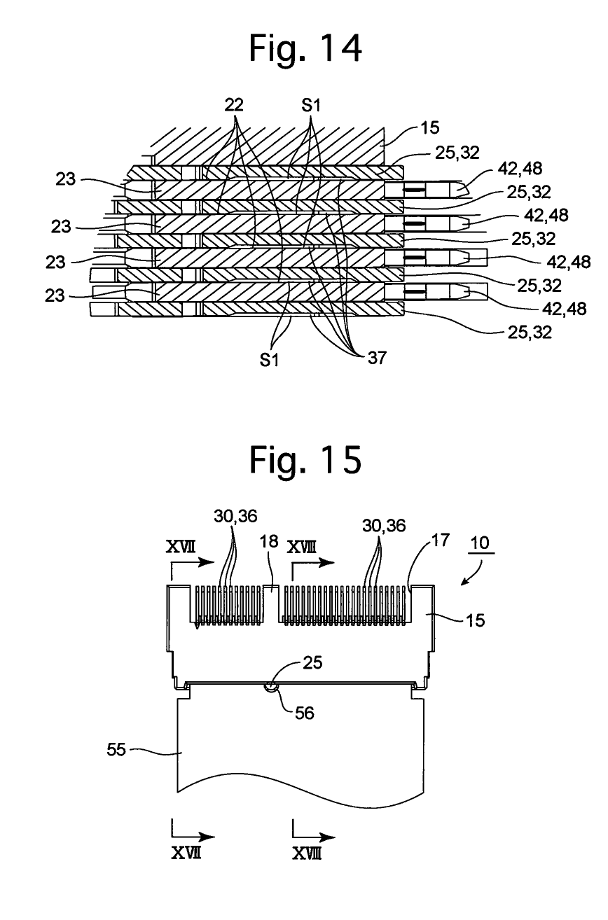

After the lower contacts 42 are mounted inside the lower-contact insertion grooves 24, when the upper contacts 30 are inserted into the upper-contact insertion grooves 22, respectively, from the rear side of the insulator 15, the upper contacts 30 stop at a position such that the front surface of the abutment projection 39 abuts against the rear end surface of the roof portion of the insulator 15. Furthermore, the upper surface of each base portion 31 abuts against the underside of the roof portion of the corresponding upper-contact insertion grooves 22, and since the lock-engagement projection 40 that projects from the underside of each base portion 31 digs (bites) into the base surface of the corresponding upper-contact insertion grooves 22, each base portion 31 is fixed to the corresponding upper-contact insertion grooves 22. As shown in FIGS. 10 and 11, upon the upper contacts 30 being mounted into the upper-contact insertion grooves 22, respectively, the elastically-deformable portion 32 (contact portion 33) of each upper contact 30 is at an upper position with respect to the position of the elastically-deformable portion 45 (contact portion 48) of each lower contacts 42, and each contact portion 33 is positioned rearward with respect to the contact portions 48. Furthermore, the tail pieces 36 of the upper contacts 30 are positioned on a common plane with the tail pieces 47 of the lower contacts 42. On the other hand, since minute (slight) gaps (space) are formed between the left and right side surfaces of the elastically-deformable portion 32 of each upper contact 30 and the left and right side surfaces of the corresponding upper-contact insertion grooves 22 (side surfaces of the partition walls 23), the elastically-deformable portion 32 is elastically deformable in the upward and downward directions within the corresponding upper-contact insertion groove 22. Furthermore, a gap S1 (which is larger than the above-mentioned gaps formed between the left and right side surfaces of the elastically-deformable portion 32 of each upper contact 30 and the left and right side surfaces of the corresponding upper-contact insertion grooves 22) is formed between the base surface (left side surface) of the recessed portion 37 formed on the left side of the elastically-deformable portion 32 of each upper contact 30 and the right side surface of the corresponding partition wall 23 positioned on the left side of the elastically-deformable portion 32 (see FIG. 14). In addition, a gap S2 (which is larger than the above-mentioned gaps formed between the left and right side surfaces of the elastically-deformable portion 32 of each upper contact 30 and the left and right side surfaces of the corresponding upper-contact insertion grooves 22) is formed between the base surface (left side surface) of the round recess 38, which is formed on the left side surface of the base portion 31 of each upper contact 30, and the right side surface of the partition wall 23 positioned on the left side of the elastically-deformable portion 32 (see FIG. 13).

The pair of left and right mounting clips 51 are press-formed from a metal plate (sheet metal), and are each provided with a mounting piece 52, forming a front portion of the mounting-clip 51, and an insertion piece 53 which extends rearwardly from the upper half portion of the mounting piece 52.

The left and right mounting clips 51 are fixed to the left and right side portions of the insulator 15 by respectively inserting the left and right insertion pieces 53 into the left and right mounting-clip installation grooves 20 from the front side of the insulator 15. Upon the insertion pieces 53 being inserted into the mounting-clip installation grooves 20, since the upper surface of each insertion piece 53 abuts against the underside of the roof portion of the corresponding mounting-clip installation grooves 20, and the lock-engagement projections formed on the underside of the insertion pieces 53 bite into the base surface of the mounting-clip installation grooves 20, the insertion pieces 53 are fixed into the mounting-clip installation grooves 20, respectively. Furthermore, upon the insertion pieces 53 being inserted into the mounting-clip installation grooves 20, the mounting pieces 52 are respectively positioned within the corresponding mounting-clip relief recesses 19, and the undersides of the mounting pieces 52 of the fixing clip 51 lie on a common plane with that of the tail pieces 36 and the tail pieces 47.

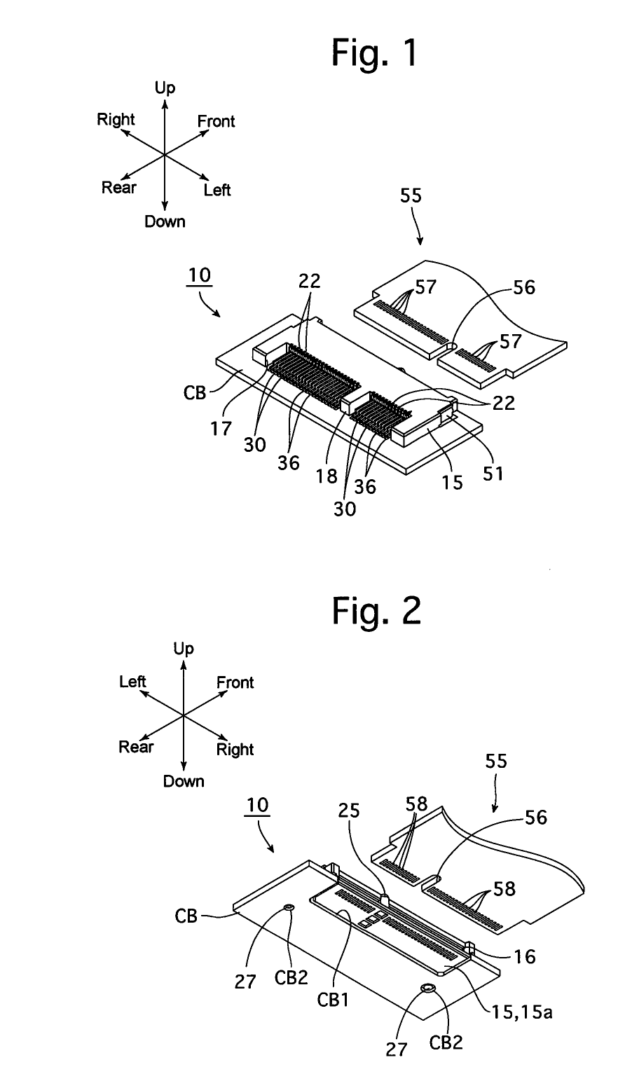

The connector 10 having the above-described configuration is installed onto a circuit board CB, shown in FIGS. 1 and 2.

A fit-engagement recess CB1, having a rectangular shape in a plan view, is formed at the front edge portion of the circuit board CB, and a pair of left and right mounting holes CB2 are formed completely through the circuit board CB. The connector 10 is installed onto the upper surface of the circuit board CB by bringing the connector 10 close to the upper surface of the circuit board CB from above, respectively fitting the left and right mounting projections 27 into the left and right mounting holes CB2 while fitting the underside projection 15a of the insulator 15 into the fit-engagement recess CB1, soldering the tail pieces 36 of the upper contacts 30 and the tail pieces 47 of the lower contacts 42 onto a circuit pattern (not shown) that is formed on the upper surface of the circuit board CB, and furthermore, by soldering the mounting pieces 52 of the mounting clips 51 onto a ground pattern (not shown) that is formed on the upper surface of the circuit board CB.

A module card board (connecting object) 55, shown in FIGS. 1 and 2, is removably insertable into the connector 10, which is installed onto the circuit board CB in the manner described above.

The card board 55 is a hard-material member that is essentially not elastically deformable. An erroneous-insertion prevention groove 56 extending in a forward direction is formed on the rear end portion of the card board 55 at a position leftward from the center, with respect to the leftward/rightward direction. A total of thirty four (34) upper terminals 57, which are arranged in the leftward/rightward direction, are provided on the upper surface of the card board 55 near the rear edge thereof, and a total of thirty four (34) lower terminals 58, which are arranged in the leftward/rightward direction, are provided on the undersurface of the card board 55 near the rear edge thereof and are positioned further rearward than the position of the upper terminals 57. The plate thickness of the card board 55 (dimensions in the upward/downward direction) is greater than the space (gap) in the upward/downward direction between the contact portions 33 of the upper contacts 30 in a free state and the contact protrusions (connecting-object support portions) 49 of the lower contacts 42 in a free state.

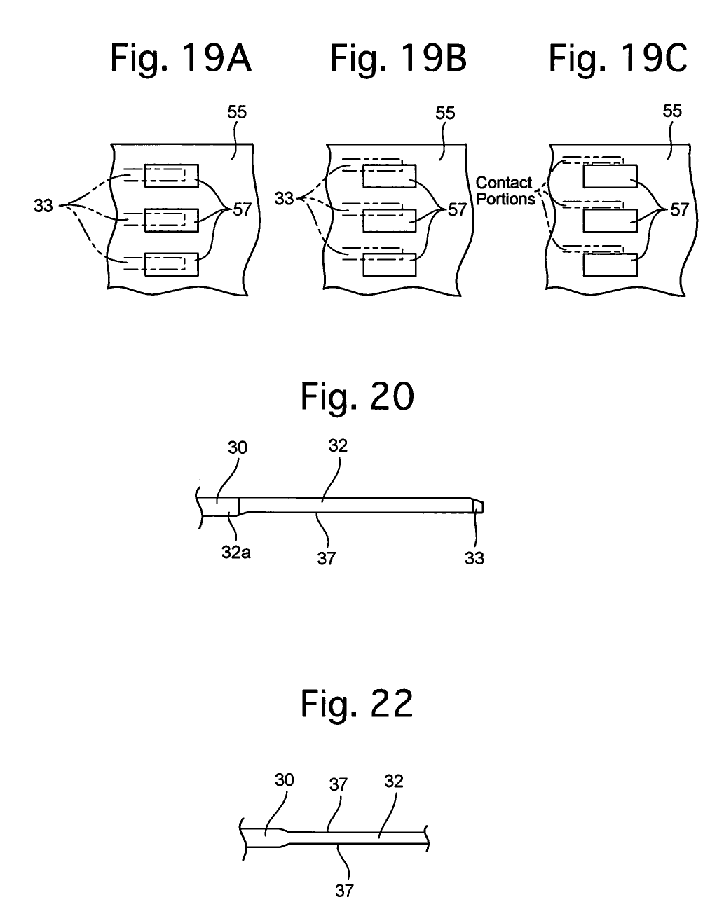

Upon the rear end of the card board 55 being inserted into the card insertion groove 16 of the connector 10 (the insertion/removal direction of the card board 55 relative to the card insertion groove 16 is the forward/rearward direction), the rear end portion of the card board 55 enters between the contact portions 33 and the contact protrusions 49 while elastically deforming the elastically-deformable portions 32 and the elastically-deformable portions 45 mutually away from each other inside the card insertion groove 16, while the erroneous-insertion prevention groove 56 fit-engages with the erroneous insertion prevention wall 25. Note that the erroneous insertion prevention wall 25 and the erroneous-insertion prevention groove 56 are formed at a position toward the left side from the centers, with respect to the leftward/rightward direction, of the insulator 15 and the card board 55. Therefore, if a worker/technician were to erroneously insert the card board 55 into the card insertion groove 16 with the card board 55 oriented upside down, since the rear end portion of the card board 55 (a portion at which the erroneous-insertion prevention groove 56 is not formed) abuts against the erroneous insertion prevention wall 25, an erroneous insertion of the card board 55 can be prevented. Furthermore, the contact portions 33 of the upper contacts 30 come in contact with the corresponding upper terminals 57 (see FIGS. 19A and 19B), and the contact protrusions 49 of the lower contacts 42 come in contact with the corresponding lower terminals 58. Accordingly, electrical conduction can be carried out between the above-mentioned circuit patterns of the circuit board CB and the card board 55 via the upper contacts 30 and the lower contacts 42.

Upon the card board 55 being inserted into the connector 10 (card insertion groove 16) with the card board 55 in a correct position in the width (leftward/rightward) direction with respect to the connector 10, i.e., in a state in which the center line of the connector 10 aligns with the center line of the card board 55, the contact portions 33 of the upper contacts 30 contact the centers of the corresponding upper terminals 57, as shown in FIG. 19A.

Furthermore, since the card board 55 has various types and a large number of manufacturers produce the card board 55, there is the practical problem of the dimensional precision tending to vary widely. In other words, it is necessary to set the width dimensions of the card insertion groove 16 (which determines the clearance occurring between the card insertion groove 16 and the card board 55 in the width direction) to be slightly large. Furthermore, if tolerance between the card insertion groove 16 and the card board 55 increases the clearance (occurring between the card insertion groove 16 and the card board 55 in the width direction), a situation can occur in which the card board 55 can significantly deviate from the correct position within the card insertion groove 16. Even if the recessed portion 37 were to be formed on the side surface of the elastically-deformable portion 32 until the contact portion 33, as shown in FIG. 20, i.e., in the case where the contact portion 33 is narrowed in width, if the card board 55 is inserted into the card insertion groove 16 at a positioned slightly deviated to one side from the correct position, there is a possibility, depending on the thin plate thickness of the upper contacts 30, of the contact portions 33 not coming in contact with the corresponding upper terminals 57, as shown in FIG. 19C. However, since the recessed portion 37 of each upper contacts 30 of the illustrated embodiment does not extend to the contact portion 33, each contact portion 33 (compared to the portion of each upper contact 30 at which the recessed portion 37 is formed) is wide (has relatively large dimensions in the leftward/rightward direction). Accordingly, even if the card board 55 were to be inserted into the card insertion groove 16 at a position slightly deviated to one side from the correct position, the contact portions 33 of the upper contacts 30 come in contact with the corresponding upper terminals 57, as shown in FIG. 19B.

Note that if the worker/technician moves the card board 55 forward by hand while grasping the card board 55, the card board 55 can be pulled forwardly out from the connector 10 (card insertion groove 16), so that the contacting state between the contact portions 33 and the upper terminals 57 and the contacting state between the contact protrusions 49 and the lower terminals 58 can be released.

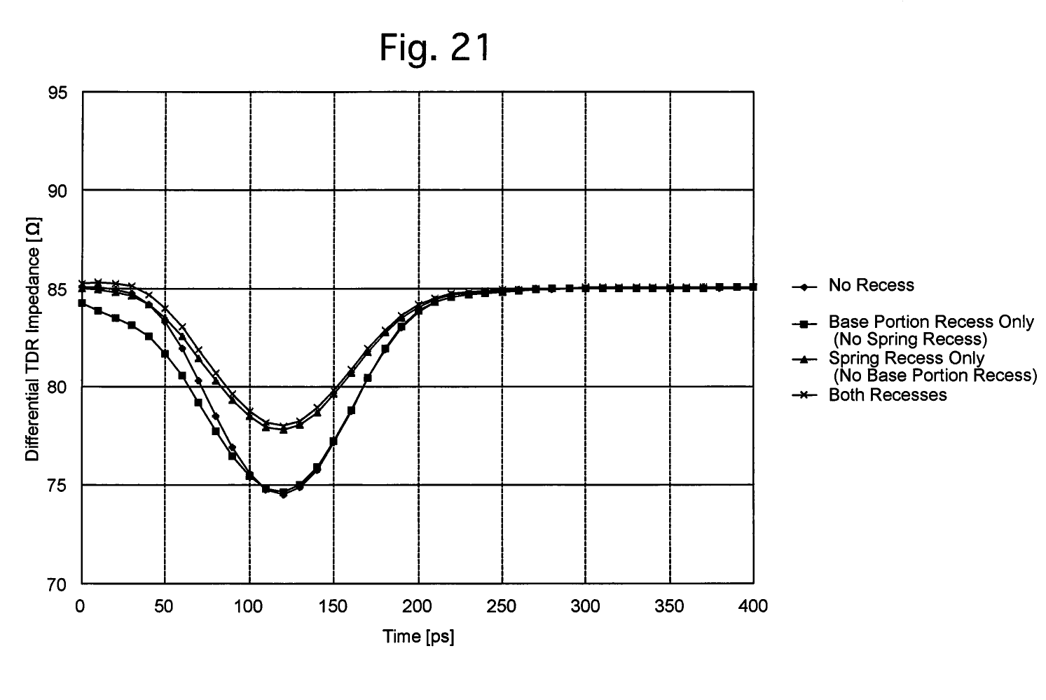

FIG. 21 is a graph showing the relationship between time and impedance (value) when an electrical current is passed through an SMA connector (coaxial-cable connector; not shown) that is connected to the circuit board CB. The horizontal axis representing time has a reference time (0) set at the time when an electrical signal is input to the connector 10. Since the electrical signals progress toward the card board 55 with time, the horizontal axis, in effect, represents each position of the signal path through the connector 10 (the upper contacts 30) and the card board 55 (the signal path at 0[ps (pico second)] to approximately 250[ps] represents the connector 10, and the signal path at approximately 250[ps] onwards represents the card board 55). Analysis was carried out using a vector network analyzer (E5071C) produced by Agilent Technologies, Inc., with a Tr (rise time) of 50 ps and a contact pitch of 0.5 mm.

FIG. 21 indicates four line graphs. The line graph having diamond shaped plots (♦) represents a connector having a configuration of that of the connector 10, but without the recessed portions 37 and the round recesses 38 (i.e., a connector of the related art), connected to the card board 55 and the circuit board CB. As can be understood from this graph, in this case the impedance of the circuit board CB and the impedance of the card board 55 are both approximately 85Ω (ohms), however, the part of the connector (contacts) with the lowest amount of impedance has an impedance of approximately 75Ω (ohms), and hence, there is a large difference between the impedance of the connector (contacts) and the impedances of the circuit board CB and the card board 55.

On the other hand, the line graph having X-mark plots (X) represents the case of the connector 10 of the illustrated embodiment. As can be understood from this graph, the impedance of the circuit board CB is approximately 85Ω (ohms) and the impedance of the card board 55 is also approximately 85Ω (ohms). However, even the part of the connector 10 (upper contacts 30) with the lowest amount of impedance has an impedance of approximately 78Ω (ohms), and hence, it can be understood that the difference between the impedance of the connector 10 (upper contacts 30) and the impedances of the circuit board CB and the card board 55 can been significantly reduced. This result is due to the gap S1 being formed between the base surface (left side surface) of the recessed portion 37 formed in the left side surface of each upper contact 30 and the right side surface of the partition wall 23 that is positioned on the left side of the corresponding elastically-deformable portion 32, and also due to the gap S2 being formed between the base surface (left side surface) of the round recess 38 formed in the left side surface of the base portion 31 of each upper contact 30 and the right side surface of the partition wall 23 positioned on the left side of the corresponding elastically-deformable portion 32. The relative permittivity of the gaps S1 and S2 (air layer) is 1, and since this relative permittivity is very low compared to the relative permittivity of the resin material that forms the insulator 15 (about 3 through 4), the coupling capacitance does not easily increase between adjacent upper contacts 30 at the portions thereof at which the recessed portions 37 and the round recesses 38 are formed; accordingly, the impedance (value) is higher than in the case of a connector having a configuration in which the recessed portions 37 and the round recesses 38 are not formed. Therefore, when the connector 10 is connected to the circuit board CB and the card board 55, the high frequency property of an electrical signal fed to the connector 10 is improved compared to the case where a connector of the related art is connected to the circuit board CB and the card board 55.

wow Although the present invention has been described based on the above illustrated embodiment, the present invention is not limited thereto; various modifications are possible.

For example, the upper contacts 30 can be provided with the recessed portions 37 while the round recesses 38 can be omitted. The graph for the connector 10 of this modified embodiment is represented by the line graph having triangular plots (▴) in FIG. 21. In this case, the impedance of the circuit board CB and the impedance of the card board 55 are both approximately 85Ω (ohms). However, even the part of the connector 10 (upper contacts 30) with the lowest amount of impedance has an impedance of approximately 78Ω (ohms), and hence, it can be understood that the difference between the impedance of the connector 10 (upper contacts 30) and the impedances of the circuit board CB and the card board 55 can been significantly reduced. Note that the line graph having square plots (▪) in FIG. 21 represent a graph in the case where the upper contacts 30 are provided with the round recesses 38 with the recessed portions 37 omitted. In this case, although the impedance of the circuit board CB and the impedance of the card board 55 are both approximately 85Ω (ohms), the part of the connector 10 (upper contacts 30) with the lowest amount of impedance has an impedance of approximately 75Ω (ohms). As can be understood from this comparison, the recessed portions 37 can greatly contribute to the reduction of the impedance of the connector 10 than the round recesses 38.

Furthermore, the upper contacts 30 of the connector 10, according to the present invention, can be implemented using the embodiment of the upper contacts 30 shown in FIG. 20.

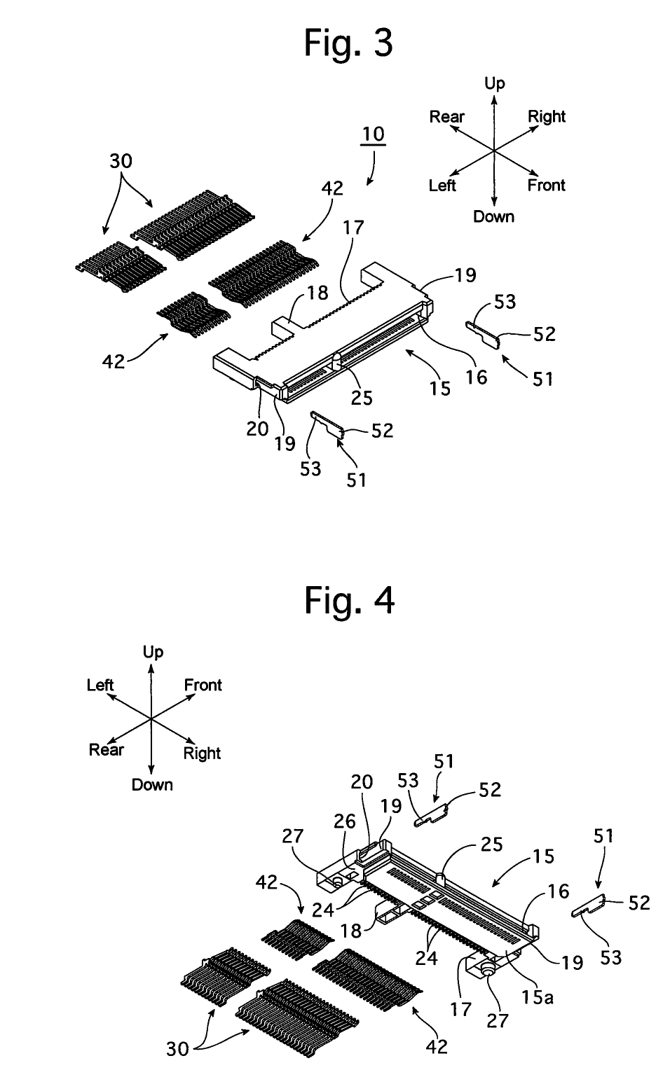

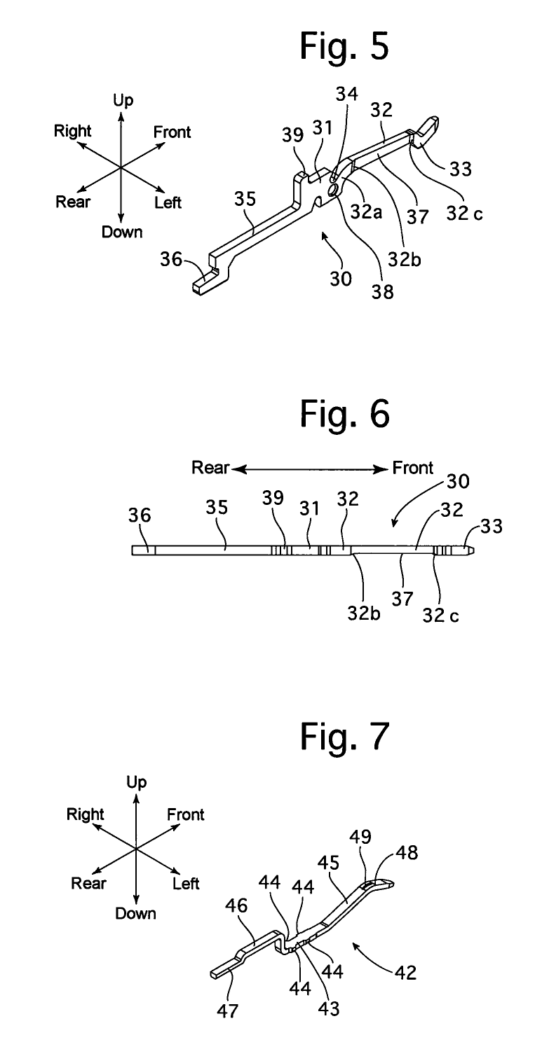

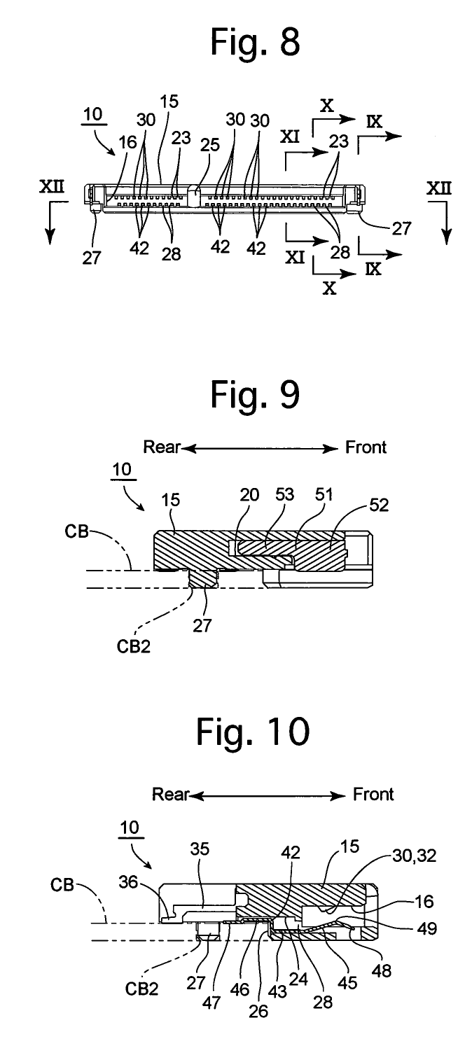

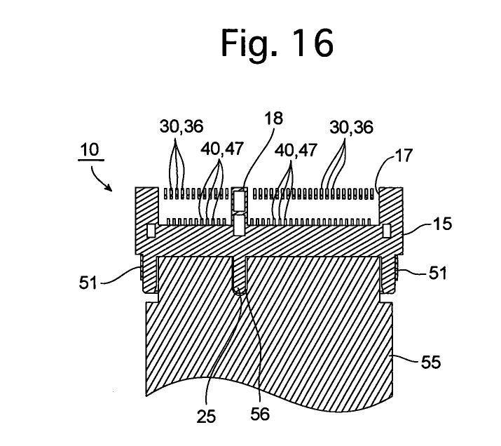

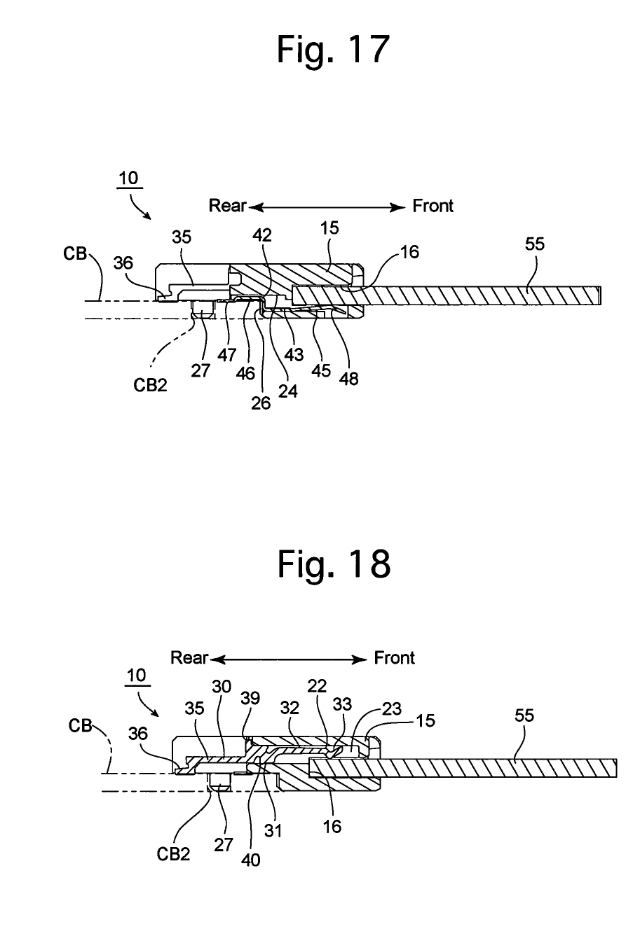

Furthermore, as shown in FIG. 22, the recessed portions 37 can be formed on the left and right side surfaces of the elastically-deformable portion 32 of each upper contact 30 (in this case, the recessed portions 37 can either extend to the contact portion 33 or not extend to the contact portion 33). If the recessed portions 37 are formed on the left and right side surfaces of the elastically-deformable portion 32 in such a manner, the impedance of the connector 10 (the upper contacts 30 and the lower contacts 42) can be expected to be reduced compared to the connector 10 shown in FIGS. 1 through 19.

Alternatively, the recessed portion 37 can be formed only on the right side of the elastically-deformable portion 32 of each upper contact 30.

Furthermore, in either case of one recessed portion 37 being formed on only one side of each elastically-deformable portion 32 and of recessed portions 37 being formed on both sides of each elastically-deformable portion 32, a configuration is acceptable in which the upper end of the recessed portion 37 does not reach the upper end of the elastically-deformable portion 32 and/or the lower end of the recessed portion 37 does not reach the lower end of the elastically-deformable portion 32.

Alternatively, the recessed portion 37 can be formed completely through the elastically-deformable portion 32 in the thickness direction (leftward/rightward direction) of the elastically-deformable portion 32.

In other words, various embodiments can be selected so long as the upper contacts 30 (elastically-deformable portions 32) can achieve their function (attain sufficient pressure contact with the card board 55 and not plastically deform, etc.).

Furthermore, in addition to forming the recessed portion 37 in the elastically-deformable portion 32, the round recesses 38 can be formed on the left and right sides of the base portion 31. In addition, in the case where the round recesses 38 can be formed on the left and right sides of the base portion 31, the round recesses 38 can be formed completely through the base portion 31 so that the round recesses 38 constitute a through-hole. In either of these cases, the impedance of the connector 10 (the upper contacts 30 and the lower contacts 42) can be expected to be reduced compared to the connector 10 shown in FIGS. 1 through 19.

Furthermore, the recessed portions 37 and/or the round recesses 38 can be formed only on some of (e.g., one) the upper contacts 30 rather than all of the upper contacts 30.

Furthermore, one of the upper contacts 30 and the lower contacts 42 can be configured as signal contacts and the other thereof can be configured as ground contacts.

Furthermore, the lower contacts 42 can be omitted from the connector 10, and the gap in the upward/downward direction between the base surface of the card insertion groove 16 (connecting-object supporting portion) and the contact portions 33 of the upper contacts 30 in a free state can be set smaller than the plate thickness (dimensions in the upward/downward direction) of the card board 55 (connecting object).

Furthermore, the gap in the upward/downward direction between the connecting-object support portion and the contact portions 33 of the upper contacts 30, in a free state, can be set larger than the plate thickness (dimension in the upward/downward direction) of the connecting object and a rotational actuator or slider for increasing the contact pressure between the contact portions 33 of the upper contacts 30 and the connecting object can be mounted onto the insulator 15.

It is also possible to use a FPC or an FFC (flexible flat cable), etc., as a thin-plate connecting object.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A connector comprising:
an insulator including a connecting-object insertion/removal groove, into which a thin plate-like connecting object having terminals on one side thereof is removably insertable, a plurality of contact insertion grooves arranged in one direction, and partition walls which partition mutually adjacent said contact insertion grooves; and
a plurality of contacts, each of said contacts including a base portion, which is fixed to said insulator, an elastically-deformable portion which is elastically deformable and extends from said base portion in an insertion/removal direction, and a contact portion which is formed on said elastically-deformable portion and comes in contact with a corresponding terminal of said terminals of said connecting object that is inserted into said connecting-object insertion/removal groove, wherein said contacts are inserted into said contact insertion grooves, respectively,
wherein a first recess is formed at a side of said elastically-deformable portion of at least one of said contacts, said first recess facing an adjacent said partition wall in said one direction and forming a space in said one direction between said first recess and said adjacent partition wall.

2. The connector according to claim 1, wherein said first recess is formed on said elastically-deformable portion over the entirety thereof, in the plate-thickness direction of said connecting object.

3. The connector according to claim 2, wherein said first recess is formed on said elastically-deformable portion at a location different to that of the front end of said elastically-deformable portion, and
wherein said contact portion is formed on said front end of said elastically-deformable portion.

4. The connector according to claim 3, wherein said first recess is formed on said elastically-deformable portion at a portion excluding a base-end portion that is communicably connected with said base portion and said front end portion.

5. The connector according to claim 1, wherein a second recess is formed on a side of said base portion of each of said contacts to which said first recess is formed, said second recess facing an adjacent said partition wall in said one direction, and wherein said second recess defines a gap between said second recess and said adjacent partition wall in said one direction.

6. The connector according to claim 1, wherein a gap between a connecting-object supporting portion that supports the other side of said connecting object, when said connecting object is inserted into said connecting-object insertion/removal groove, and said contact portion of said elastically-deformable portion, in a free state, is smaller than a plate thickness of said connecting object.
